(19) United States
(12) Patent Application Publication
(10) Pub. No.: US 2026/0050233 A1
(43) Pub. Date: Feb. 19, 2026

(54) TRANSPORT DEVICE AND IMAGE FORMING APPARATUS

(71) Applicant: FUJIFILM Business Innovation Corp., Tokyo (JP)

(72) Inventors: Kohei IKENAGA, Kanagawa (JP); Satoshi WATANABE, Kanagawa (JP); Yuki KOHNO, Kanagawa (JP); Yuya CHONABAYASHI, Kanagawa (JP)

(73) Assignee: FUJIFILM Business Innovation Corp., Tokyo (JP)

(21) Appl. No.: 19/046,474

(22) Filed: Feb. 5, 2025

(30) Foreign Application Priority Data
Aug. 16, 2024 (JP) 2024-137039

(51) Int. Cl. G03G 15/00

(52) U.S. Cl. CPC G03G 15/6573; G03G 2215/00675

(57) ABSTRACT

A transport device includes a transporting roller that includes a first shaft portion, a first roller configured to have plural cylindrical first roller portions into which the first shaft portion is inserted and which are separated from each other in an axial direction of the first shaft portion, and a second roller coming into contact with the first roller and extends in a direction of the first shaft portion, and that transports a recording medium; and a guide member that is disposed on a first roller side with respect to a transport path of the recording medium and that is formed with a guide surface guiding the recording medium toward the transporting roller while changing a transport direction of the recording medium to be transported, the guide surface of a separation portion which is separated from the first roller in the axial direction extending to a downstream side in the transport direction as compared with the guide surface of an overlapping portion which overlaps the first roller in the axial direction.

### CROSS-REFERENCE TO RELATED APPLICATIONS

This application is based on and claims priority under 35 USC 119 from Japanese Patent Application No. 2024-137039 filed Aug. 16, 2024.

### BACKGROUND

### (i) Technical Field

The present invention relates to a transport device and an image forming apparatus.

### (ii) Related Art

A recording material processing device disclosed in JP2008-63071A includes a forming portion that forms a waveform shape on a recording material, a movement portion that moves the forming portion in a direction intersecting a transport direction on a surface of the recording material, a guide portion that is provided to be movable in the direction intersecting the transport direction on the surface of the recording material and that guides the transported recording material to the forming portion, and an interlocking unit that moves the guide portion in conjunction with the movement of the forming portion by the movement portion.

### SUMMARY

There is a transport device that changes a transport direction of a recording medium while bending a recording medium. The transport device includes a transporting roller that transports a recording medium, and a guide member in which a guide surface for guiding the recording medium toward the transporting roller while changing the transport direction of the recording medium to be transported is formed.

In the related art, the guide member is separated from the transporting roller as viewed from the axial direction of the transporting roller, and the shape of the guide surface of the guide member is constant in the axial direction of the transporting roller. Here, when the rear end of the recording medium transported by the transporting roller is disengaged from the guide surface of the guide member, a bouncing sound is generated due to the bouncing.

Aspects of non-limiting embodiments of the present disclosure relate to a transport device and an image forming apparatus that suppresses a bouncing sound when a rear end of a recording medium is disengaged from a guide surface as compared with a case where the guide member is separated from the transporting roller as viewed from the axial direction of the transporting roller and the shape of the guide surface is constant in the axial direction of the transporting roller.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transport device includes a transporting roller that includes a first shaft portion, a first roller configured to have a plurality of cylindrical first roller portions into which the first shaft portion is inserted and which are separated from each other in an axial direction of the first shaft portion, and a second roller coming into contact with the first roller and extends in a direction of the first shaft portion, and that transports a recording medium; and a guide member that is disposed on a first roller side with respect to a transport path of the recording medium and that is formed with a guide surface guiding the recording medium toward the transporting roller while changing a transport direction of the recording medium to be transported, the guide surface of a separation portion which is separated from the first roller in the axial direction extending to a downstream side in the transport direction as compared with the guide surface of an overlapping portion which overlaps the first roller in the axial direction.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to an exemplary embodiment of the present disclosure;

FIG. 2 is a schematic configuration diagram showing the image forming apparatus to form an image according to the exemplary embodiment of the present disclosure;

FIG. 3 is a front view showing a transport device according to the exemplary embodiment of the present disclosure;

FIG. 4 is a perspective view showing the transport device according to the exemplary embodiment of the present disclosure and a state in which a discharge roller is disposed at an initial position;

FIG. 5 is a perspective view showing the transport device according to the exemplary embodiment of the present disclosure and a state in which the discharge roller is disposed at a discharge position;

FIG. 6A and FIG. 6B are front views showing a guide member provided in the transport device according to the exemplary embodiment of the present disclosure;

FIGS. 7A and 7B are status views showing a situation in which a leading end of a sheet member is guided and a situation in which the sheet member P is fed in the guide member provided in the transport device according to the exemplary embodiment of the present disclosure;

FIGS. 8A and 8B are side views showing the guide member and the discharge roller provided in the transport device according to the exemplary embodiment of the present disclosure in a state of being disposed at the initial position and a state of being disposed at the discharge position;

FIGS. 9A and 9B are front views showing the guide member provided in the transport device according to the exemplary embodiment of the present disclosure;

FIGS. 10A and 10B are front views showing the guide member provided in the transport device according to the exemplary embodiment of the present disclosure;

FIG. 11 is a perspective view showing the guide member provided in the transport device according to the exemplary embodiment of the present disclosure from below; and

FIG. 12 is a perspective view showing a discharge roller provided in a transport device according to a modification embodiment of the exemplary embodiment of the present disclosure.

### DETAILED DESCRIPTION

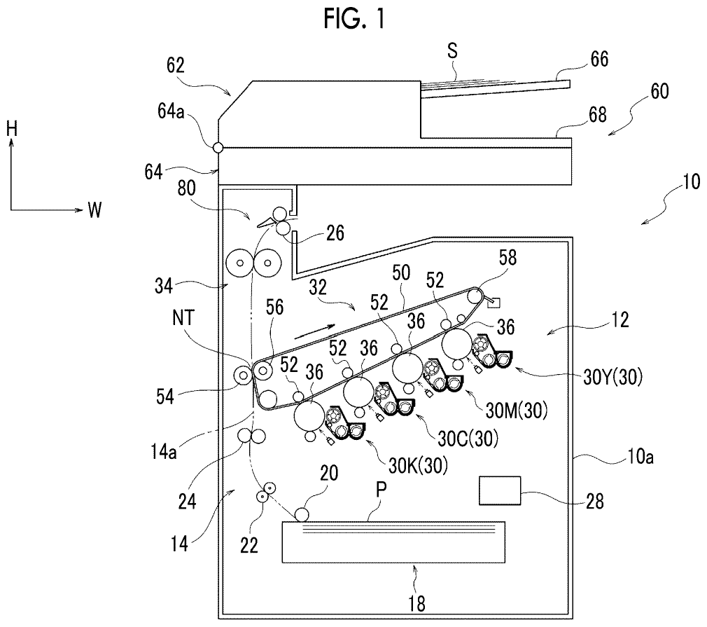

An example of a transport device and an image forming apparatus according to an exemplary embodiment of the present disclosure will be described with reference to FIGS. 1 to 12. The arrow H shown in each drawing indicates a vertical direction, which is an up-down direction of the apparatus. The arrow W is orthogonal to the arrow H and indicates the width direction of the apparatus in a horizontal direction. The arrow D is orthogonal to the arrows H and W and indicates the depth direction of the apparatus in the horizontal direction.

### Overall Configuration of Image Forming Apparatus 10

As shown in FIG. 1, an image forming apparatus 10 includes an image reading unit 60 and an image forming unit 12 that forms a toner image. Further, the image forming apparatus 10 includes a transport device 14 that transports a sheet member P along a transport path 14a. In addition, the image forming apparatus 10 includes an accommodating member 18 that accommodates the sheet member P as a recording medium, and a control unit 28 that controls the entire apparatus.

In this configuration, in the image forming apparatus 10, the transport device 14 transports the sheet member P accommodated in the accommodating member 18 along the transport path 14a. Further, the image forming unit 12 forms a toner image based on the image data read by the image reading unit 60. Further, the sheet member P to which the toner image is transported and the sheet member P on which the toner image is formed is discharged to the outside of the device main body 10a.

### Image Forming Unit 12

As shown in FIG. 1, the image forming unit 12 includes a plurality of toner image forming units 30 that each forms the toner image of each color. In addition, the image forming unit 12 includes a transfer unit 32 that transfers the toner image formed by the toner image forming unit 30 to the sheet member P. Further, the image forming unit 12 includes a fixing device 34 that fixes the toner images, which are transferred to the sheet member P by the transfer unit 32, to the sheet member P.

### Toner Image Forming Unit 30

The plurality of toner image forming units 30 are provided to form toner images for respective colors. In the present exemplary embodiment, in total, four colors of yellow (Y), magenta (M), cyan (C), and black (K) toner image forming units 30Y, 30M, 30C, and 30K are provided. In the following description, in a case where there is no need to distinguish between yellow (Y), magenta (M), cyan (C), and black (K), Y, M, C, and K attached as the reference numerals are omitted.

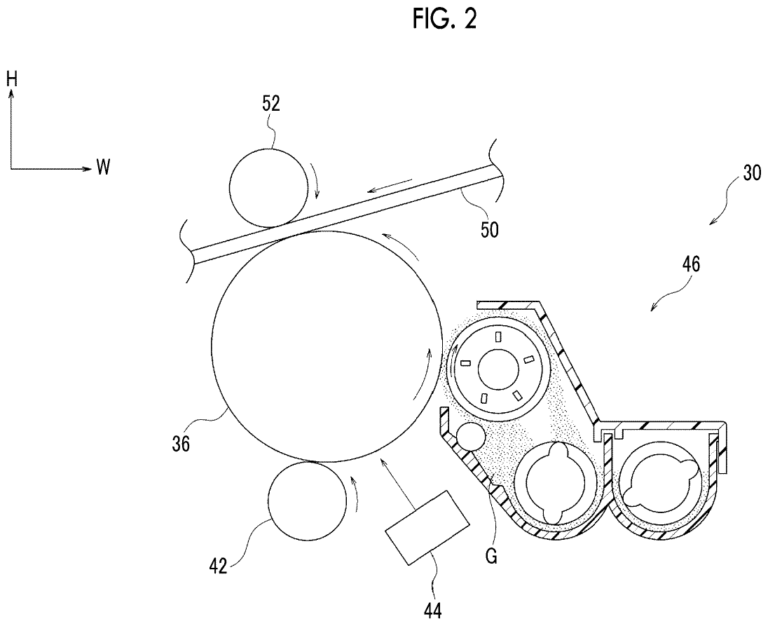

The toner image forming units 30 of respective colors have basically the same configuration except for a toner to be used and, as shown in FIG. 2, each includes a rotating image holder 36 having a columnar shape and a charger 42 that charges the image holder 36. Further, the toner image forming unit 30 includes an exposure device 44 that irradiates the charged image holder 36 with exposure light to form an electrostatic latent image. In addition, the toner image forming unit 30 includes a developing device 46 that develops an electrostatic latent image as a toner image using a developer G containing a toner. As a result, the toner image forming unit 30 of each color forms an image of each color using a toner of each color.

In addition, as shown in FIG. 1, the image holder 36 of each color is in contact with a transfer belt 50 (details to be described below) that moves circumferentially. In a circumferential direction (see an arrow in the drawing) of the transfer belt 50, the yellow (Y), magenta (M), cyan (C), and black (K) toner image forming units 30 are arranged in turn from an upstream side.

### Transfer Unit 32

As shown in FIG. 1, the transfer unit 32 includes an endless transfer belt 50. Further, the transfer unit 32 includes a primary transfer roller 52 that is disposed on each of the opposite sides of the image holder 36 of each color with the transfer belt 50 interposed therebetween and that transfers the toner image formed on the image holder 36 of each color to the transfer belt 50.

In addition, the transfer unit 32 includes a winding roller 56 around which the transfer belt 50 is wound, and a drive roller 58 around which the transfer belt 50 is wound and which transmits a rotational force to the transfer belt 50. As a result, the transfer belt 50 is circumferentially driven in an arrow direction in the drawing.

Further, the transfer unit 32 is disposed on an opposite side of the winding roller 56 with the transfer belt 50 interposed therebetween, and includes a secondary transfer roller 54 that transfers the toner image transferred to the transfer belt 50 to the sheet member P. A transfer nip NT where the toner image is transferred to the sheet member P is formed between the secondary transfer roller 54 and the transfer belt 50.

### Fixing Device 34

As shown in FIG. 1, the fixing device 34 is arranged on a downstream side of the transfer nip NT in a transport direction of the sheet member P. The fixing device 34 heats and pressurizes a toner image transferred to the sheet member P to fix the toner image to the sheet member P.

In this configuration, the toner image is primarily transferred to the transfer belt 50 by the primary transfer roller 52 in order of yellow (Y), magenta (M), cyan (C), and black (K). In addition, the toner image is transferred from the transfer belt 50 to the sheet member P interposed and transported between the transfer belt 50 and the secondary transfer roller 54 by the secondary transfer roller 54.

Further, the sheet member P to which the toner image is transferred is transported toward the fixing device 34.

The fixing device 34 heats and pressurizes the toner image transferred to the sheet members P, and fixes the toner image on the sheet members P.

### Transport Device 14

As shown in FIG. 1, the transport device 14 includes a feeding roller 20 that feeds the sheet member P accommodated in the accommodating member 18 to the transport path 14a. In addition, the transport device 14 includes a double feeding prevention roller 22 that prevents the double feeding of the sheet member P fed by the feeding roller 20, and an adjustment roller 24 that adjusts the timing of feeding the sheet member P to the transfer nip NT. Further, the transport device 14 includes a discharge roller 26 that discharges the sheet member P to the outside of the device main body 10a, and a guide unit 80 that guides the sheet member P on which the toner image is fixed by the fixing device 34 toward the discharge roller 26.

The guide unit 80, the discharge roller 26, and the like provided in the transport device 14 will be described in detail later.

### Image Reading Unit 60

As shown in FIG. 1, the image reading unit 60 is disposed above the discharge roller 26. The image reading unit 60 includes a document transport unit 62 and a document reading unit 64. In addition, the document transport unit 62 and the document reading unit 64 are connected to each other by a hinge portion 64a provided in the document reading unit 64. Further, the image reading unit 60 includes a paper feed tray 66 that feeds a document S to the document transport unit 62 and a discharge tray 68 that discharges the document S read by the document reading unit 64. The paper feed tray 66 and the discharge tray 68 are attached to the document transport unit 62.

In this configuration, the document transport unit 62 is rotated around the hinge portion 64a, so that the upper surface (platen glass) of the document reading unit 64 is opened upward. Then, the document reading unit 64 reads the image of the document S placed on a platen glass (not shown) disposed on the upper surface of the document reading unit 64 and the image of the document S transported by the document transport unit 62.

### Major Configuration

Next, the guide unit 80 and the discharge roller 26, which are provided in the transport device 14, a movement portion 90, which moves the discharge roller 26, and the like will be described.

### Discharge Roller 26

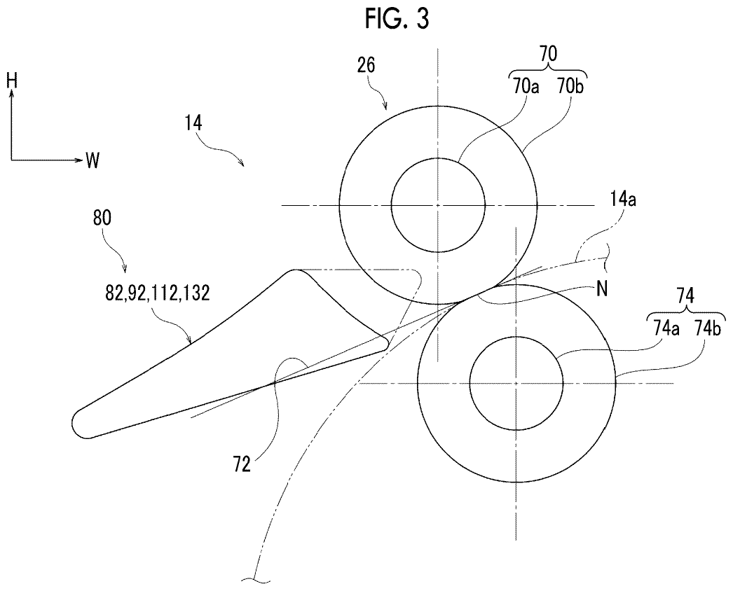

As shown in FIGS. 1 and 3, the discharge roller 26 is disposed at an end portion of the transport path 14a such that the sheet member P to be transported is discharged to one side (right side in the drawing) in the width direction. The discharge roller 26 includes a first roller 70 and a second roller 74 disposed on the lower side of the first roller 70, as shown in FIG. 3, with the axial direction as the depth direction. The discharge roller 26 is an example of a transporting roller, and the depth direction is an example of an axial direction.

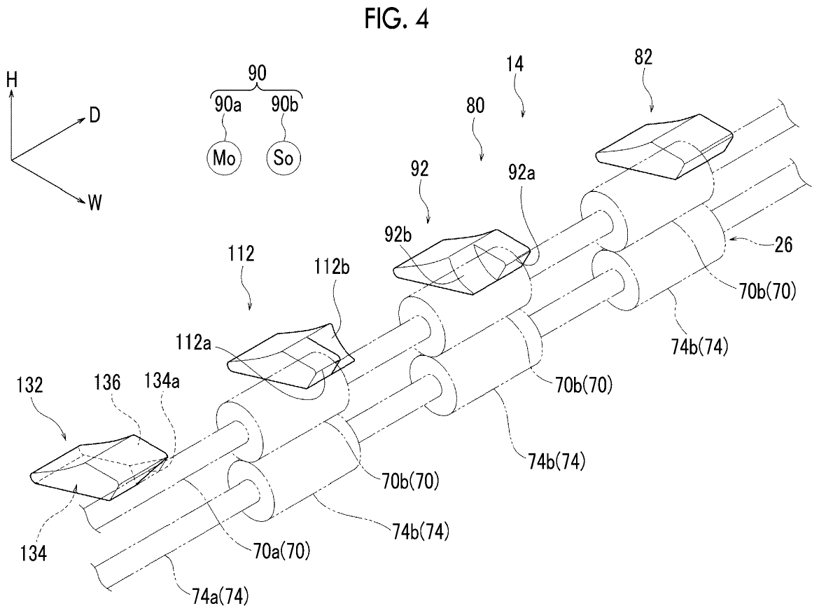

As shown in FIGS. 3 and 4, the first roller 70 includes a first shaft portion 70a having a columnar shape extending in the depth direction. Further, the first roller 70 includes a cylindrical first roller portion 70b into which the first shaft portion 70a is inserted. The first roller portion 70b is formed of an elastic member and a plurality of the first roller portions 70b are provided to be separated from each other in the depth direction.

Similarly, the second roller 74 includes a second shaft portion 74a, which extends in the depth direction and has a columnar shape, and a cylindrical second roller portion 74b into which the second shaft portion 74a is inserted. The second roller portion 74b is formed of an elastic member and a plurality of second roller portions 74b are provided to be separated from each other in the depth direction. Further, in the depth direction, each of the second roller portions 74b is disposed at the same position as each of the first roller portions 70b.

Then, as shown in FIG. 3, a nip portion N that sandwiches the sheet member P is formed by the first roller 70 and the second roller 74. The nip portion N is formed in such a way that the first roller portion 70b formed of an elastic member and the second roller portion 74b formed of an elastic member are pressed.

The nip portion N has a linear shape as viewed from the depth direction along the transport direction of the sheet member P (hereinafter, referred to as a “sheet transport direction”). A straight line including the nip portion N as viewed in the depth direction is referred to as a nip line 72. In the present exemplary embodiment, the nip line 72 is a perpendicular bisector to a line segment connecting the center of the first shaft portion 70a and the center of the second shaft portion 74a as viewed from the depth direction.

### Movement Portion 90

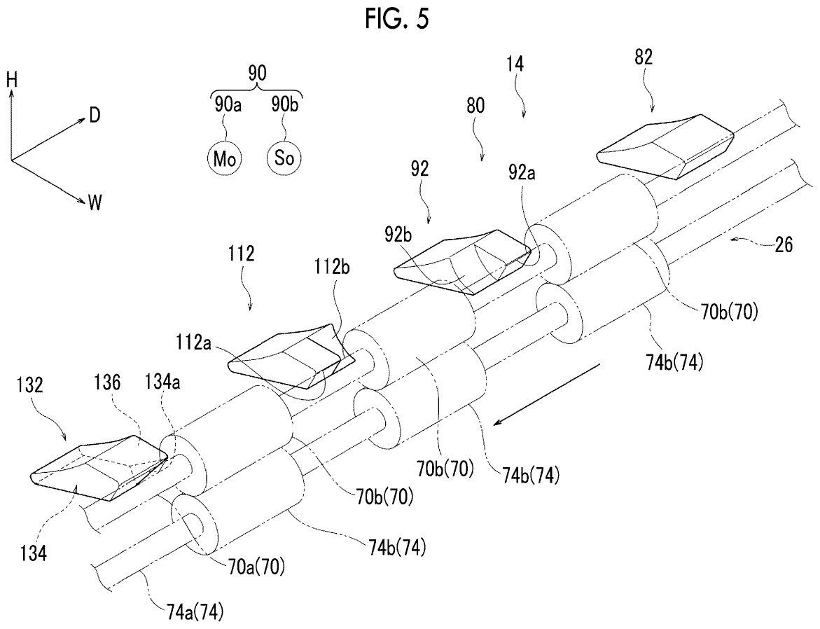

As shown in FIGS. 4 and 5, the movement portion 90 includes a motor 90a that rotates the first roller 70. Further, the movement portion 90 includes a solenoid 90b that moves the first roller 70 and the second roller 74 in the depth direction.

In this configuration, the motor 90a rotates the first roller 70, and the second roller 74 is driven and rotated. Then, the discharge roller 26 sandwiches the sheet member P to be transported at the nip portion N (see FIG. 3) and transports the sheet member P to the downstream side in the sheet transport direction.

On the other hand, the discharge position of the sheet member P may be changed in the width direction (depth direction) of the sheet member P for each image forming instruction (job). Specifically, the discharge positions of the sheet member P on which the image is formed by a first image forming instruction and the sheet member P on which the image is formed by a next image forming instruction may be changed.

In such a case, in a first discharge operation, the discharge roller 26 discharges the sheet member P to the first position outside the device main body 10a in a state in which the discharge roller 26 is disposed at one position (initial position) without moving the position of the discharge roller 26 in the depth direction (see FIG. 4). On the other hand, in a next discharge operation, the solenoid 90b moves the discharge roller 26, which sandwiches the leading end portion of the sheet member P, to another position which is different from the initial position on the front side in the depth direction (see FIG. 5). Then, the discharge roller 26 discharges the sheet member P to a second position different from the first position in a state of being moved to another position. Further, after the discharge roller 26 discharges the sheet member P, the solenoid 90b moves the discharge roller 26 to the back side in the depth direction to be returned to the initial position. In this way, a first position at which the sheet member P is discharged by the first discharge operation and a second position at which the sheet member P is discharged by the next discharge operation are changed.

### Guide Unit 80

As shown in FIGS. 1 and 3, the guide unit 80 is disposed on the side of the first roller 70 with respect to the transport path 14a between the fixing device 34 and the discharge roller 26 in the sheet transport direction. The guide unit 80 guides the sheet member P toward the discharge roller 26 while changing the transport direction of the sheet member P fed upward from the fixing device 34. Here, the transport path 14a is an ideal path through which the center of gravity of the sheet member P transported by each roller passes.

As shown in FIGS. 4 and 5, the guide unit 80 includes four guide members 82, 92, 112, and 132. The guide members 82, 92, 112, and 132 are arranged in the depth direction in this order from the back side to the front side in the depth direction. The guide members 82, 92, 112, and 132 are supported by a frame member (not shown).

### Guide Member 82

As shown in FIGS. 4 and 5, the guide member 82 is disposed on the back side in the depth direction with respect to the first roller portion 70b and the second roller portion 74b disposed on the most back side in the depth direction. Specifically, even in a state where the discharge roller 26 is disposed at one position or even in a state where the discharge roller 26 is disposed at another position, the guide member 82 is disposed on the back side in the depth direction with respect to the first roller portion 70b and the second roller portion 74b.

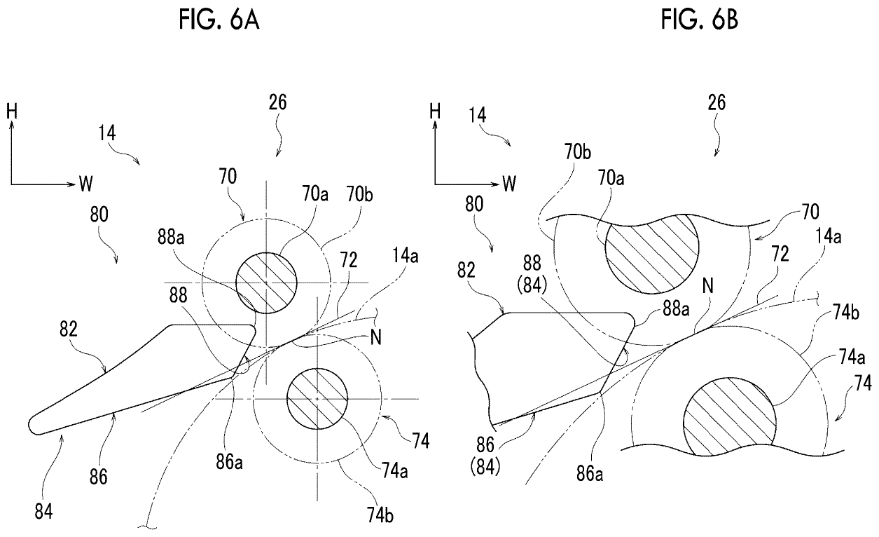

In addition, the guide member 82 extends in the depth direction and has the same cross section in the depth direction. Specifically, as shown in FIGS. 6A and 6B, a guide surface 84 facing the transport path 14a is formed on the guide member 82. The guide surface 84 is divided into a first guide surface 86 on the upstream side in the sheet transport direction and a second guide surface 88 on the downstream side in the sheet transport direction.

The first guide surface 86 has a function of guiding the leading end of the sheet member P to be transported to the nip portion N. Therefore, the first guide surface 86 is separated from the first roller portion 70b and the second roller portion 74b as viewed from the depth direction. Further, the leading end 86a of the first guide surface 86 is disposed on the side of the second roller 74 with respect to the nip line 72.

In addition, the second guide surface 88 has a planar shape and has a function of suppressing the rear end of the sheet member P to be transported from being bounced up when the rear end passes through the first guide surface 86. Therefore, with the nip line 72 as a reference, the second guide surface 88 extends from the leading end 86a of the first guide surface 86 to the side of the nip line 72, and the leading end 88a of the second guide surface 88 is disposed on the side of the first roller 70 with respect to the nip line 72. On the other hand, with the first shaft portion 70a as a reference, the second guide surface 88 extends from the leading end 86a of the first guide surface 86 to the side of the first shaft portion 70a, and the leading end 88a of the second guide surface 88 overlaps the first roller portion 70b as viewed from the depth direction.

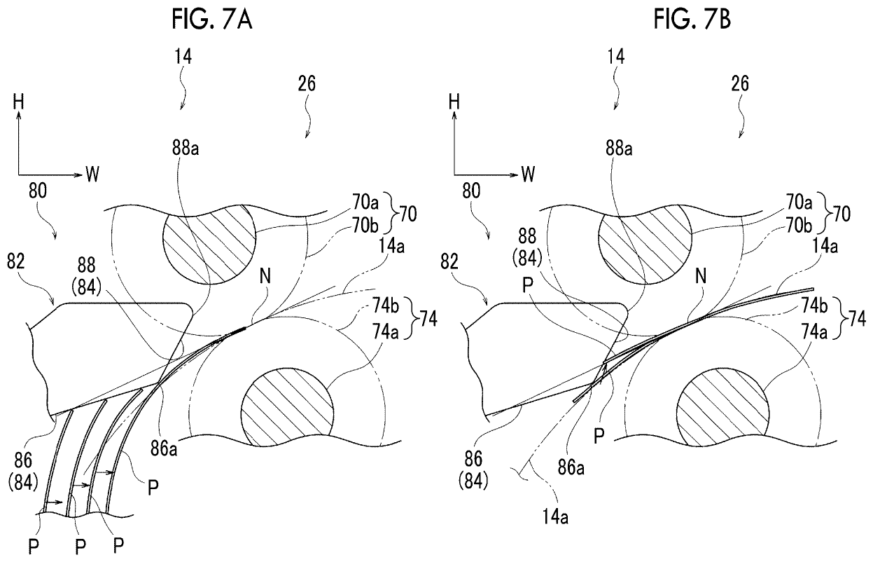

In this configuration, in a case where the leading end of the sheet member P is transported toward the nip portion N, the leading end of the sheet member P is guided by the first guide surface 86 as shown in FIG. 7A. Then, the leading end of the sheet member P is fed from the leading end 86a of the first guide surface 86 toward the nip portion N. As described above, the first guide surface 86 has a function of guiding the leading end of the sheet member P to be transported to the nip portion N.

On the other hand, in a case where the rear end of the sheet member P to be transported is separated from the guide surface 84, as shown in FIG. 7B, the sheet member P is transported while the sheet surface of the sheet member P is in contact with the leading end 86a of the first guide surface 86. Then, when the rear end of the sheet member P passes through the leading end 86a, the rear end of the sheet member P is likely to bounce due to the rigidity of the sheet member P. However, the rear end of the sheet member P is suppressed from being bounced up by the second guide surface 88. As described above, the second guide surface 88 has a function of suppressing the rear end of the sheet member P to be transported from being bounced up when the rear end passes through the first guide surface 86.

### Guide Member 92

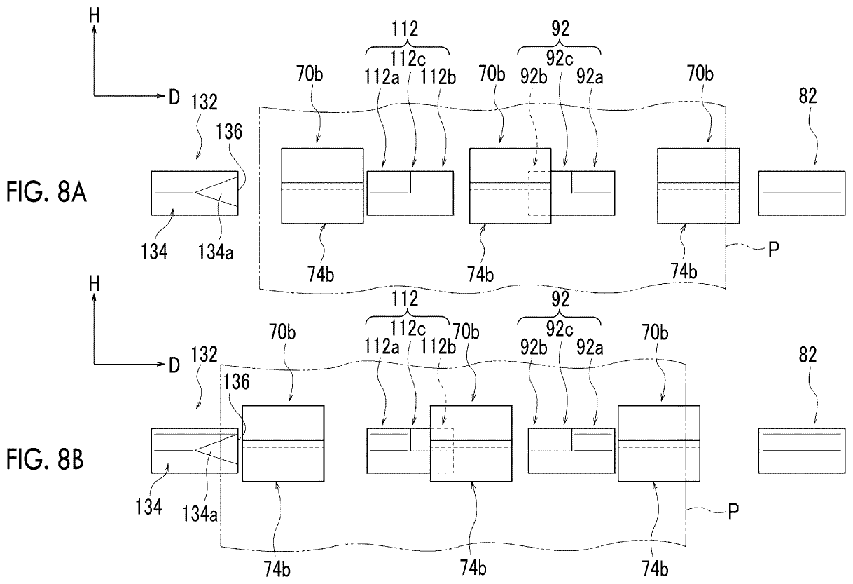

As shown in FIGS. 4 and 5, the guide member 92 is disposed on the front side in the depth direction with respect to the guide member 82. Specifically, in a state in which the discharge roller 26 is disposed at one position, a part of the guide member 92 overlaps the first roller portion 70b and the second roller portion 74b in the depth direction as shown in FIGS. 4 and 8A. In other words, another part of the guide member 92 is separated from the first roller portion 70b and the second roller portion 74b in the depth direction. On the other hand, in a state in which the discharge roller 26 is disposed at another position, the guide member 92 does not overlap the first roller portion 70b and the second roller portion 74b in the depth direction as shown in FIGS. 5 and 8B.

In FIGS. 8A and 8B, the first shaft portion 70a and the second shaft portion 74a are omitted so that the relative positional relationship between the guide members 82, 92, 112, and 132 and the first roller portion 70b and the second roller portion 74b can be easily understood.

In the following description, in a state in which the discharge roller 26 is disposed at one position (initial position), a guide member 92 of a portion separated from the first roller portion 70b and the second roller portion 74b in the depth direction is referred to as a separation portion 92a. Further, the guide member 92 overlapping the first roller portion 70b and the second roller portion 74b in the depth direction is referred to as an overlapping portion 92b. Further, a portion connecting the separation portion 92a and the overlapping portion 92b is referred to as a connection portion 92c.

### Separation Portion 92a

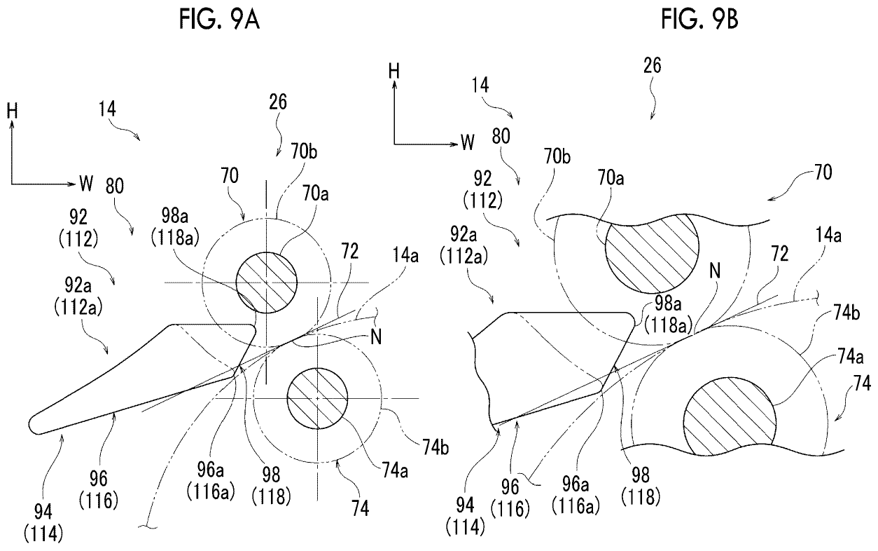

As shown in FIGS. 9A and 9B, a guide surface 94 facing the transport path 14a is formed on the separation portion 92a. The guide surface 94 is divided into a first guide surface 96 on the upstream side in the sheet transport direction and a second guide surface 98 on the downstream side in the sheet transport direction. The first guide surface 96 overlaps the first guide surface 86 of the guide member 82 as viewed from the depth direction. Further, the second guide surface 98 overlaps the second guide surface 88 of the guide member 82 as viewed from the depth direction.

The first guide surface 96 has a function of guiding the leading end of the sheet member P to be transported to the nip portion N. Therefore, the first guide surface 96 is separated from the first roller portion 70b and the second roller portion 74b as viewed from the depth direction. Further, the leading end 96a of the first guide surface 96 is disposed on the side of the second roller 74 with respect to the nip line 72.

In addition, the second guide surface 98 has a planar shape and has a function of suppressing the rear end of the sheet member P to be transported from being bounced up when the rear end passes through the first guide surface 96. Therefore, with the nip line 72 as a reference, the second guide surface 98 extends from the leading end 96a of the first guide surface 96 to the side of the nip line 72, and the leading end 98a of the second guide surface 98 is disposed on the side of the first roller 70 with respect to the nip line 72. On the other hand, with the first shaft portion 70a as a reference, the second guide surface 98 extends from the leading end 96a of the first guide surface 96 to the side of the first shaft portion 70a, and the leading end 98a of the second guide surface 98 overlaps the first roller portion 70b as viewed from the depth direction. The leading end 98a is an example of a leading end of the guide surface of the separation portion.

### Overlapping Portion 92b

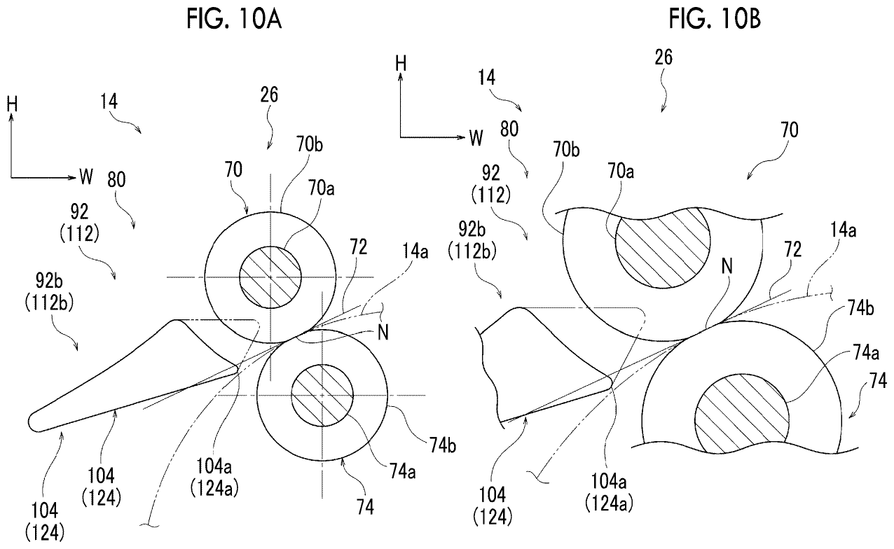

As shown in FIGS. 10A and 10B, the overlapping portion 92b is separated from the discharge roller 26 as viewed from the depth direction, and a guide surface 104 facing the transport path 14a is formed on the overlapping portion 92b. The guide surface 104 overlaps the first guide surface 96 of the separation portion 92a as viewed from the depth direction (see FIG. 9). In other words, the guide surface 104 overlaps the first guide surface 86 of the guide member 82 as viewed from the depth direction.

The guide surface 104 has a function of guiding the leading end of the sheet member P to be transported to the nip portion N. Therefore, the guide surface 104 is separated from the first roller portion 70b and the second roller portion 74b as viewed from the depth direction. Further, the leading end 104a of the guide surface 104 is disposed on the side of the second roller 74 with respect to the nip line 72. The leading end 104a is an example of a leading end of the guide surface of the overlapping portion.

### Connection Portion 92c

The cross-sectional shape of the connection portion 92c shown in FIG. 8 is the same as the overlapping portion 92b.

### Guide Member 112

As shown in FIGS. 4 and 5, the guide member 112 is disposed on the front side in the depth direction with respect to the guide member 92. Specifically, in a state in which the discharge roller 26 is disposed at another position, a part of the guide member 112 overlaps the first roller portion 70b and the second roller portion 74b in the depth direction as shown in FIGS. 5 and 8B. In other words, another part of the guide member 112 is separated from the first roller portion 70b and the second roller portion 74b in the depth direction. On the other hand, in a state in which the discharge roller 26 is disposed at one position, the guide member 112 does not overlap the first roller portion 70b and the second roller portion 74b in the depth direction as shown in FIGS. 4 and 8A.

In the following description, in a state in which the discharge roller 26 is disposed at another position, a guide member 112 of a portion separated from the first roller portion 70b and the second roller portion 74b in the depth direction is referred to as a separation portion 112a. Further, the guide member 112 of the portion overlapping the first roller portion 70b and the second roller portion 74b in the depth direction is referred to as an overlapping portion 112b. Further, a portion connecting the separation portion 112a and the overlapping portion 112b is referred to as a connection portion 112c.

### Separation Portion 112a

As shown in FIGS. 9A and 9B, a guide surface 114 facing the transport path 14a is formed on the separation portion 112a. The guide surface 114 is divided into a first guide surface 116 on the upstream side in the sheet transport direction and a second guide surface 118 on the downstream side in the sheet transport direction. The first guide surface 116 overlaps the first guide surface 86 of the guide member 82 as viewed from the depth direction. Further, the second guide surface 118 overlaps the second guide surface 88 of the guide member 82 as viewed from the depth direction.

The first guide surface 116 has a function of guiding the leading end of the sheet member P to be transported to the nip portion N. Therefore, the first guide surface 116 is separated from the first roller portion 70b and the second roller portion 74b as viewed from the depth direction. Further, the leading end 116a of the first guide surface 116 is disposed on the side of the second roller 74 with respect to the nip line 72.

In addition, the second guide surface 118 has a planar shape and has a function of suppressing the rear end of the sheet member P to be transported from being bounced up when the rear end passes through the first guide surface 116. Therefore, with the nip line 72 as a reference, the second guide surface 118 extends from the leading end 116a of the first guide surface 116 to the side of the nip line 72, and the leading end 118a of the second guide surface 118 is disposed on the side of the first roller 70 with respect to the nip line 72. On the other hand, with the first shaft portion 70a as a reference, the second guide surface 118 extends from the leading end 116a of the first guide surface 116 to the side of the first shaft portion 70a, and the leading end 118a of the second guide surface 118 overlaps the first roller portion 70b as viewed from the depth direction. The leading end 118a is an example of a leading end of the guide surface of the separation portion.

### Overlapping Portion 112b

As shown in FIGS. 10A and 10B, the overlapping portion 112b is separated from the discharge roller 26 as viewed from the depth direction, and a guide surface 124 facing the transport path 14a is formed on the overlapping portion 112b. The guide surface 124 overlaps the first guide surface 116 of the separation portion 112a as viewed from the depth direction (see FIG. 9). In other words, the guide surface 124 overlaps the first guide surface 86 of the guide member 82 as viewed from the depth direction.

The guide surface 124 has a function of guiding the leading end of the sheet member P to be transported to the nip portion N. Therefore, the guide surface 124 is separated from the first roller portion 70b and the second roller portion 74b as viewed from the depth direction. Further, the leading end 124a of the guide surface 124 is disposed on the side of the second roller 74 with respect to the nip line 72. The leading end 124a is an example of a leading end of the guide surface of the overlapping portion.

### Connection Portion 112c

The cross-sectional shape of the connection portion 112c shown in FIG. 8 is the same as the overlapping portion 112b.

### Guide Member 132

As shown in FIGS. 4 and 5, the guide member 132 is disposed on the front side in the depth direction with respect to the guide member 112. Specifically, even in a state where the discharge roller 26 is disposed at one position or even in a state where the discharge roller 26 is disposed at another position, the guide member 132 is disposed on the front side with respect to the first roller portion 70b and the second roller portion 74b. Therefore, the basic shape of the guide member 132 is the same as the guide member 82. The guide member 132 is an example of another guide member.

However, as described above, the discharge position of the sheet member P discharged by the discharge roller 26 may be changed in the depth direction. Specifically, the discharge rolls 26 may sandwich the sheet material P at one position, and may move to another position to discharge the sheet material P. In such a case, the sheet member P moves to the downstream side in the sheet transport direction and also moves in the depth direction.

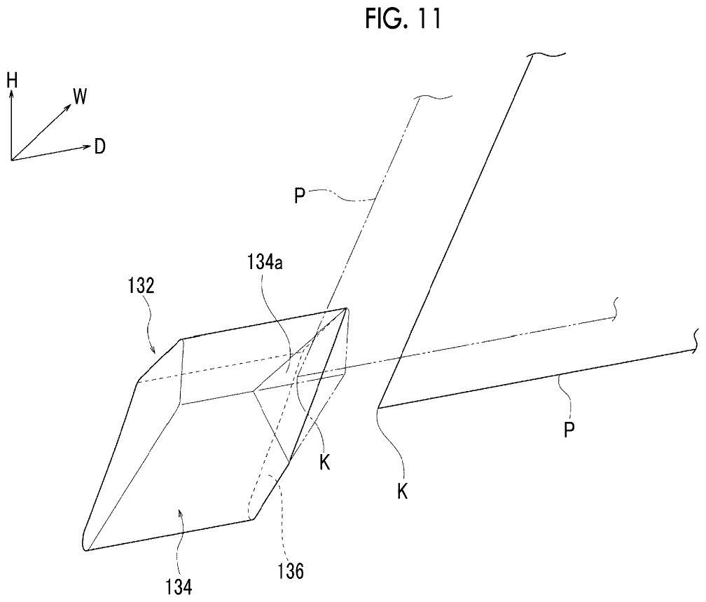

Therefore, as shown in FIG. 11, a rear end corner portion K of the sheet member P moves to the downstream side in the sheet transport direction while moving in the depth direction. Then, the rear end corner portion K of the sheet member P is in contact with the guide surface 134 of the guide member 132.

Here, on the guide surface 134, an inclined surface 134a inclined with respect to the depth direction is formed so that the rear end corner portion K of the moving sheet member P does not come into contact with the side surface 136 of the guide member 132. Accordingly, the rear end corner portion K of the moving sheet member P comes into contact with the inclined surface 134a formed on the guide surface 134.

### SUMMARY

As described above, in the transport device 14, the guide surfaces 94 and 114 of the separation portions 92a and 112a of the guide members 92 and 112 extend to the downstream side in the sheet transport direction as compared with the guide surfaces 104 and 124 of the overlapping portions 92b and 112b. Therefore, the rear end of the sheet member P to be transported is suppressed from being bounced up by the guide surfaces 94 and 114 of the separation portions 92a and 112a. Accordingly, the bouncing sound is suppressed when the rear end of the sheet member P is disengaged from the guide surface as compared with a case where the guide member is separated from the discharge roller as viewed from the depth direction and the shape of the guide surface is constant in the depth direction.

In addition, in the transport device 14, the leading ends 104a and 124a of the guide surfaces 104 and 124 of the overlapping portions 92b and 112b of the guide members 92 and 112 are disposed on the side of the second roller 74 with respect to the nip line 72 as viewed from the depth direction. Further, the leading ends 98a and 118a of the second guide surfaces 98 and 118 of the separation portions 92a and 112a of the guide members 92 and 112 extend toward the nip line 72 from the leading ends 104a and 124a of the guide surfaces 104 and 124 of the overlapping portions 92b and 112b. As a result, the bouncing sound is suppressed as compared with a case where the second guide surface is parallel to the nip line as viewed from the depth direction.

In addition, in the transport device 14, the leading ends 98a and 118a of the second guide surfaces 98 and 118 of the separation portions 92a and 112a of the guide members 92 and 112 are disposed on the side of the first roller 70 with respect to the nip line 72 as viewed from the depth direction. As a result, the bouncing sound is suppressed as compared with a case where the leading end of the guide surface of the separation portion is disposed on the second roller side with respect to the nip line.

In addition, in the transport device 14, the leading ends 104a and 124a of the guide surfaces 104 and 124 of the overlapping portions 92b and 112b of the guide members 92 and 112 are disposed on the side of the second roller 74 with respect to the nip line 72 as viewed from the depth direction. Further, the leading ends 98a and 118a of the second guide surfaces 98 and 118 of the separation portions 92a and 112a of the guide members 92 and 112 extend from the leading ends 104a and 124a of the guide surfaces 104 and 124 of the overlapping portions 92b and 112b toward the side of the first roller 70. As a result, the bouncing sound is suppressed as compared with a case where the leading end of the overlapping portion of the guide surface extends to the second roller side.

In addition, in the transport device 14, the leading ends 98a and 118a of the second guide surfaces 98 and 118 of the separation portions 92a and 112a of the guide members 92 and 112 overlap the first roller 70 as viewed from the depth direction. As a result, the bouncing sound is suppressed as compared with a case where the leading end of the separation portion is separated from the first roller as viewed from the depth direction.

In addition, in the transport device 14, an inclined surface 134a that is inclined with respect to the depth direction is formed on the guide surface 134 of the guide member 132. In addition, the rear end corner portion K of the sheet member P comes into contact with the inclined surface 134a when the discharge roller 26 moves. As a result, the damage (so-called “dog ear”) to the rear end corner portion K is suppressed as compared with a case where the rear end corner portion K of the sheet member P is in contact with the side surface of the guide member that is directed in the depth direction.

In addition, the image forming apparatus 10 includes the transport device 14. Therefore, the transport sound is reduced as compared with a case where the transport member having only the guide member of which the shape of the guide surface is constant in the depth direction is provided.

Although the specific exemplary embodiments of the present disclosure are described in detail, the exemplary embodiment of the present disclosure is not limited to such exemplary embodiments, and it is apparent to those skilled in the art that various other exemplary embodiments can be taken within the scope of the present disclosure. For example, in the above-described exemplary embodiment, the discharge roller 26 has been described as an example, but any transporting roller that receives the sheet member P whose transport direction is changed may be used, the present disclosure is not particularly limited to the discharge roller and may be a normal transporting roller.

In addition, in the above-described exemplary embodiment, the discharge roller 26 is moved in the axial direction, but may not be moved. In this case, the inclined surface 134a of the guide member 132 is not necessary.

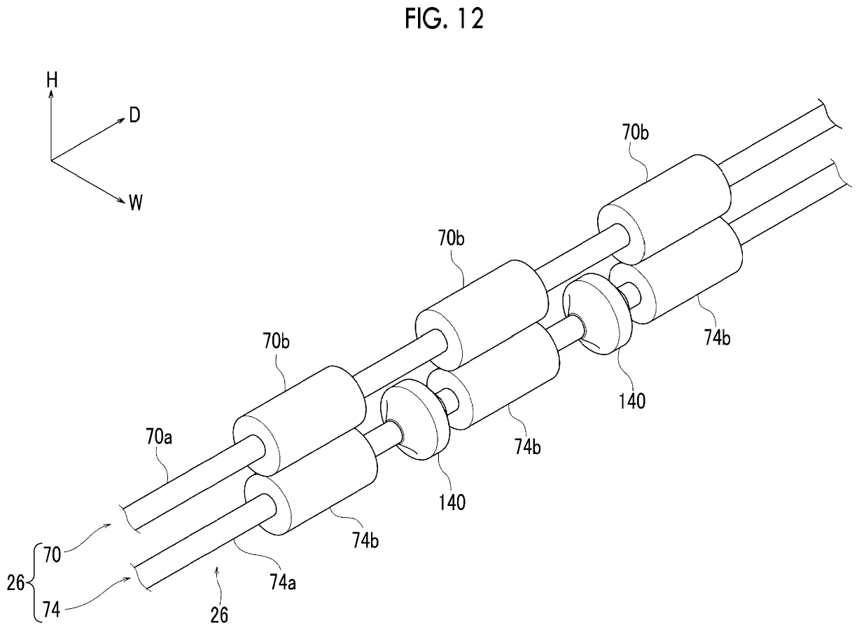

In addition, in the above-described exemplary embodiment, although not particularly described, as shown in FIG. 12, the discharge roller 26 may include a corrugation roller 140 that corrugates the sheet member P.
(((1)))

A transport device comprising:
a transporting roller that includes a first shaft portion, a first roller configured to have a plurality of cylindrical first roller portions into which the first shaft portion is inserted and which are separated from each other in an axial direction of the first shaft portion, and a second roller coming into contact with the first roller and extends in a direction of the first shaft portion, and that transports a recording medium; and
a guide member that is disposed on a first roller side with respect to a transport path of the recording medium and that is formed with a guide surface guiding the recording medium toward the transporting roller while changing a transport direction of the recording medium to be transported, the guide surface of a separation portion which is separated from the first roller in the axial direction extending to a downstream side in the transport direction as compared with the guide surface of an overlapping portion which overlaps the first roller in the axial direction.
(((2)))

The transport device according to ((1)),
wherein a leading end of the guide surface of the overlapping portion is disposed on a second roller side with respect to a nip line between the first roller and the second roller as viewed from the axial direction, and
the guide surface of the separation portion extends from the leading end of the guide surface of the overlapping portion to a nip line side as viewed in the axial direction.
(((3)))

The transport device according to (((1))),
wherein a leading end of the guide surface of the separation portion is disposed on the first roller side with respect to a nip line as viewed in the axial direction.
(((4)))

The transport device according to (((1))),
wherein a leading end of the guide surface of the overlapping portion is disposed on a second roller side with respect to a nip line between the first roller and the second roller as viewed from the axial direction, and
the guide surface of the separation portion extends from the leading end of the guide surface of the overlapping portion to a first shaft portion side as viewed in the axial direction.
(((5)))

The transport device according to (((4))),
wherein the leading end of the guide surface of the separation portion overlaps the first roller portion as viewed in the axial direction.
(((6)))

The transport device according to any one of (((1))) to (((5))),
wherein the transporting roller is a discharge roller that discharges the recording medium to an outside of a device main body,
the discharge roller disposed at one position discharges the recording medium to be transported to a first position, and includes
   a movement portion that moves the discharge roller pinching a leading end portion of the recording medium to be transported from the one position in the axial direction to be disposed at another position, and that discharges the recording medium to a second position different from the first position,
   another guide member that is disposed on a first roller side with respect to a transport path of the recording medium and that is formed with another guide surface guiding the recording medium toward the discharge roller while changing the transport direction of the recording medium to be transported and coming in contact with a rear end corner portion of the recording medium to be transported in the axial direction due to movement of the discharge roller, and
   an inclined surface that is formed on the other guide surface, that is inclined with respect to the axial direction, and that comes into contact with the rear end corner portion when the discharge roller moves.
(((7)))

An image forming apparatus comprising:
the transport device according to any one of (((1))) to (((6))); and
an image forming unit that forms an image on the recording medium transported by the transport device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transport device comprising:
a transporting roller that includes a first shaft portion, a first roller configured to have a plurality of cylindrical first roller portions into which the first shaft portion is inserted and which are separated from each other in an axial direction of the first shaft portion, and a second roller coming into contact with the first roller and extends in a direction of the first shaft portion, and that transports a recording medium; and
a guide member that is disposed on a first roller side with respect to a transport path of the recording medium and that is formed with a guide surface guiding the recording medium toward the transporting roller while changing a transport direction of the recording medium to be transported, the guide surface of a separation portion which is separated from the first roller in the axial direction extending to a downstream side in the transport direction as compared with the guide surface of an overlapping portion which overlaps the first roller in the axial direction.

2. The transport device according to claim 1,
wherein a leading end of the guide surface of the overlapping portion is disposed on a second roller side with respect to a nip line between the first roller and the second roller as viewed from the axial direction, and
the guide surface of the separation portion extends from the leading end of the guide surface of the overlapping portion to a nip line side as viewed in the axial direction.

3. The transport device according to claim 2,
wherein the leading end of the guide surface of the separation portion is disposed on the first roller side with respect to the nip line as viewed in the axial direction.

4. The transport device according to claim 1,
wherein a leading end of the guide surface of the overlapping portion is disposed on a second roller side with respect to a nip line between the first roller and the second roller as viewed from the axial direction, and
the guide surface of the separation portion extends from the leading end of the guide surface of the overlapping portion to a first shaft portion side as viewed in the axial direction.

5. The transport device according to claim 4,
wherein the leading end of the guide surface of the separation portion overlaps the first roller portion as viewed in the axial direction.

6. The transport device according to claim 1,
wherein the transporting roller is a discharge roller that discharges the recording medium to an outside of a device main body,
the discharge roller disposed at one position discharges the recording medium to be transported to a first position, and includes
a movement portion that moves the discharge roller pinching a leading end portion of the recording medium to be transported from the one position in the axial direction to be disposed at another position, and that discharges the recording medium to a second position different from the first position,
another guide member that is disposed on a first roller side with respect to a transport path of the recording medium and that is formed with another guide surface guiding the recording medium toward the discharge roller while changing the transport direction of the recording medium to be transported and coming in contact with a rear end corner portion of the recording medium to be transported in the axial direction due to movement of the discharge roller, and
an inclined surface that is formed on the other guide surface, that is inclined with respect to the axial direction, and that comes into contact with the rear end corner portion when the discharge roller moves.

7. An image forming apparatus comprising:
the transport device according to claim 1; and
an image forming unit that forms an image on the recording medium transported by the transport device.

8. An image forming apparatus comprising:
the transport device according to claim 2; and
an image forming unit that forms an image on the recording medium transported by the transport device.

9. An image forming apparatus comprising:
the transport device according to claim 3; and
an image forming unit that forms an image on the recording medium transported by the transport device.

10. An image forming apparatus comprising:
the transport device according to claim 4; and
an image forming unit that forms an image on the recording medium transported by the transport device.

11. An image forming apparatus comprising:
the transport device according to claim 5; and
an image forming unit that forms an image on the recording medium transported by the transport device.

12. An image forming apparatus comprising:
the transport device according to claim 6; and
an image forming unit that forms an image on the recording medium transported by the transport device.
